(19) United States
(12) Patent Application Publication
(10) Pub. No.: US 2021/0317330 A1
(43) Pub. Date: Oct. 14, 2021

(54) COATING COMPOSITION AND COATED ARTICLE

(71) Applicant: LION PENCIL CO., LTD., New Taipei City (TW)

(72) Inventor: Hung-Jen CHANG, New Taipei City (TW)

(21) Appl. No.: 17/008,661

(22) Filed: Sep. 1, 2020

(30) Foreign Application Priority Data
Apr. 14, 2020 (TW) 109112528

(51) Int. Cl. C09D 133/02; C09D 127/06

(52) U.S. Cl. CPC C09D 133/02; C09D 127/06

(57) ABSTRACT

A coating composition includes a primary adhesive, a modifier, a smoothing agent, a filler, a secondary adhesive, and a pigment. The primary adhesive is in an amount of about 65.0-85.0 wt % based on the total weight of the coating composition. The modifier is in an amount of about 5.0-15.0 wt % based on the total weight of the coating composition. The smoothing agent is in an amount of about 5.0-15.0 wt % based on the total weight of the coating composition. The filler is in an amount of about 1.0-3.0 wt % based on the total weight of the coating composition. The secondary adhesive is in an amount of about 0.5-10.0 wt % based on the total weight of the coating composition. The pigment is in an amount of about 1.0-10.0 wt % based on the total weight of the coating composition.

### CROSS-REFERENCE TO RELATED APPLICATION

This application claims priority to Taiwan Application Serial Number 109112528, filed Apr. 14, 2020, which is herein incorporated by reference.

### BACKGROUND

### Field of Invention

The present disclosure relates to a coating composition and a coated article.

### Description of Related Art

Generally, oil-based paints added with organic solvents, such as nitrocellulose Lacquers, etc., not only cause environmental pollution issues but also damage human health due to volatilization of the organic solvents during drying. In addition, the oil-based paints usually need to be applied multiple times to achieve the desired quality. During multiple coating processes, after the oil paint is applied to the substrate, it is necessary to wait for it to dry before the next coating. Therefore, the coating efficiency of using the oil-based paint is low, which in turn affects productivity.

In addition, general water-based paints do not have the issues of volatile solvents, but those are not easy to dry. Therefore, drying equipment (such as dryers, conveyor belts, etc.) is usually required to accelerate drying, so additional space is required to accommodate the drying equipment. In addition, the water-based paints tend to absorb moisture from the environment, resulting in unstable coating quality.

### SUMMARY

According to some embodiments of the present disclosure, a coating composition is provided, which includes a primary adhesive, a modifier, a smoothing agent, a filler, a secondary adhesive, and a pigment. The primary adhesive is in an amount of about 65.0 to about 85.0 wt % based on the total weight of the coating composition. The modifier is in an amount of about 5.0 to about 15.0 wt % based on the total weight of the coating composition. The smoothing agent is in an amount of about 5.0 to about 15.0 wt % based on the total weight of the coating composition. The filler is in an amount of about 1.0 to about 3.0 wt % based on the total weight of the coating composition. The secondary adhesive is in an amount of about 0.5 to about 10.0 wt % based on the total weight of the coating composition. The pigment is in an amount of about 1.0 to about 10.0 wt % based on the total weight of the coating composition.

According to some embodiments of the present disclosure, the primary adhesive includes polyester, polyurethane (PU), polyvinyl chloride (PVC), ethylene-vinyl acetate (EVA) copolymer or a combination thereof.

According to some embodiments of the present disclosure, the primary adhesive is ethylene-vinyl acetate copolymer and has a melting point of about 70° C. to about 100° C.

According to some embodiments of the present disclosure, in the ethylene-vinyl acetate copolymer, vinyl acetate is in an amount of about 5.0 to about 40.0 wt % based on the total weight of the ethylene-vinyl acetate copolymer.

According to some embodiments of the present disclosure, the ethylene-vinyl acetate copolymer has a melt flow index of about 20 to about 90 g/10 min.

According to some embodiments of the present disclosure, the primary adhesive is polyurethane and has a melting point of about 110° C. to about 140° C.

According to some embodiments of the present disclosure, the polyurethane has a melt flow index of about 15 to about 30 g/10 min.

According to some embodiments of the present disclosure, the modifier includes low density polyethylene (LDPE), high density polyethylene (HDPE), linear low density polyethylene (LLDPE) or a combination thereof.

According to some embodiments of the present disclosure, the smoothing agent includes beeswax, paraffin wax, microcrystalline wax, polyethylene wax (PE wax) or a combination thereof.

According to some embodiments of the present disclosure, the filler includes talcum powder, zinc stearate, calcium stearate, calcium carbonate or a combination thereof.

According to some embodiments of the present disclosure, the secondary adhesive includes maleic acid resin, alkyl phenolic resin, rosin pentaerythritol ester, hydrogenated hydrocarbon resin or a combination thereof.

According to some embodiments of the present disclosure, the coating composition has a melting point of about 100° C. to about 180° C.

According to some embodiments of the present disclosure, a coated article is provided, which includes a substrate and a coating layer. The coating layer covers a surface of the substrate, and the coating layer includes the above-mentioned coating composition.

According to some embodiments of the present disclosure, the substrate includes wood.

### BRIEF DESCRIPTION OF THE DRAWINGS

Various aspects of the present disclosure will be fully understood from the following detailed description when reading the accompanying drawings. It is worth noting that various features are not drawn to scale in accordance with standard practice in the industry. In fact, dimensions of the various features may be arbitrarily increased or decreased for clarity of discussion.

FIG. 1 is a schematic diagram of a coated article according to some embodiments of the present disclosure.

### DETAILED DESCRIPTION

One aspect of the present disclosure provides a coating composition, which includes a primary adhesive, a modifier, a smoothing agent, a filler, a secondary adhesive, and a pigment. In some embodiments, a melting point of the coating composition is in a range of from 100° C. to 180° C. Details of each component in the coating composition are described below.

The primary adhesive is in an amount of about 65.0 to about 85.0 wt % based on the total weight of the coating composition, for example, about 66, 68, 70, 72, 75, 80, 82, or 84 wt %. The primary adhesive with the above content range can make the coating composition have good adhesion. If the content of the primary adhesive is less than 65 wt %, the coating adhesion is poor; if it is greater than 85 wt %, a viscosity of the coating composition is high, which makes the molding difficult. In some embodiments, the primary adhesive includes polyester, polyurethane (PU), polyvinyl chloride (PVC), ethylene-vinyl acetate (EVA) copolymer or a combination thereof.

In some embodiments, the primary adhesive may be ethylene-vinyl acetate copolymer, which has a melting point of about 70° C. to about 100° C. This melting point range of the primary adhesive is close to melting points of other components in the coating composition, which is suitable for formulation operation of the coating composition. In addition, the melting point of the primary adhesive will affect the melting point of the coating composition. In some embodiments, vinyl acetate is in an amount of about 5.0 to about 40.0 wt % based on the total weight of the ethylene-vinyl acetate copolymer, for example, about 7, 10, 15, 20, 23, 25, 30, 35, 37 or 39 wt %. The ethylene-vinyl acetate copolymer having the above vinyl acetate content has good adhesion and is suitable for application in coatings. In some embodiments, the ethylene-vinyl acetate copolymer has a melt flow index of about 20 to about 90 g/10 min, for example, about 25, 30, 35, 40, 45, 50, 55, 60, 65, 70, 75, 80 or 85 g/10 min. The coating composition containing ethylene-vinyl acetate copolymer with this melt flow index range has the best adhesion to wooden poles, such that it is suitable for coating wooden poles.

In other embodiments, the primary adhesive may be polyurethane, which has a melting point of about 110° C. to about 140° C. The coating composition including the polyurethane with this melting point range as the primary adhesive and other additives has the most suitable fluidity and viscosity for coating on wooden poles. In some embodiments, polyurethane has a melt flow index of about 15 to about 30 g/10 min, for example, about 17, 20, 22, 25, 28 or 29 g/10 min. The coating composition containing polyurethane with this melt flow index range has the best adhesion to wooden poles.

The modifier is in an amount of about 5.0 to about 15.0 wt % based on the total weight of the coating composition, for example, about 7, 10, 11, 13, or 14 wt %. The modifier has good chemical stability and can be resistant to aqueous solution of acid, alkali or salt. Therefore, adding the modifier with the above content range can enhance stability of the coating composition. In some embodiments, the modifier includes low density polyethylene (LDPE), high density polyethylene (HDPE), linear low density polyethylene (LLDPE) or a combination thereof.

The smoothing agent is in an amount of about 5.0 to about 15.0 wt % based on the total weight of the coating composition, for example, about 6, 8, 10, 13 or 14 wt %. If the content of the smoothing agent is less than 5 wt %, a coating surface formed after curing of the coating composition is rough; if the content of the smoothing agent is greater than 15 wt %, coating adhesion of the coating composition is poor. In some embodiments, the smoothing agent includes beeswax, paraffin wax, microcrystalline wax, polyethylene wax (PE wax) or a combination thereof.

The filler is in an amount of about 1.0 to about 3.0 wt % based on the total weight of the coating composition, for example, about 1.2, 1.5, 2, 2.3, 2.5, or 2.7 wt %. In some embodiments, the filler includes talcum powder, zinc stearate, calcium stearate, calcium carbonate or a combination thereof.

The secondary adhesive is in an amount of about 0.5 to about 10.0 wt % based on the total weight of the coating composition, for example, about 0.8, 1, 1.5, 3, 5, 7, 8, or 9. Adding the secondary adhesive with the above content range can make the coating composition have good adhesion. If the content of the secondary adhesive is less than 0.5 wt %, the coating adhesion is poor; if it is greater than 10.0 wt %, viscosity of the coating composition will be too high, making molding difficult. In some embodiments, the secondary adhesive includes maleic acid resin, alkyl phenolic resin, rosin pentaerythritol ester, hydrogenated hydrocarbon resin or a combination thereof.

The pigment is in an amount of about 1.0 to about 10.0 wt % based on the total weight of the coating composition, for example, about 2, 3, 5, 7, 8, or 9. In some embodiments, the pigment includes an organic pigment, an inorganic pigment, or a combination thereof. In some embodiments, the pigment has good temperature resistance, so that the pigment still has good stability when the coating composition is molten. For example, the pigment can be C.I. Pigment White 6, C.I. Pigment Red 101, 170, 185, C.I. Pigment Orange 13, 34, C.I. Pigment Yellow 1, 3, 42, 55, C.I. Pigment Blue 15:1, 15:3, C.I. Pigment Green 7, C.I. Pigment Black 7, C.I. Pigment Violet 23, aluminum, mica, or ferric oxide, but not limited thereto.

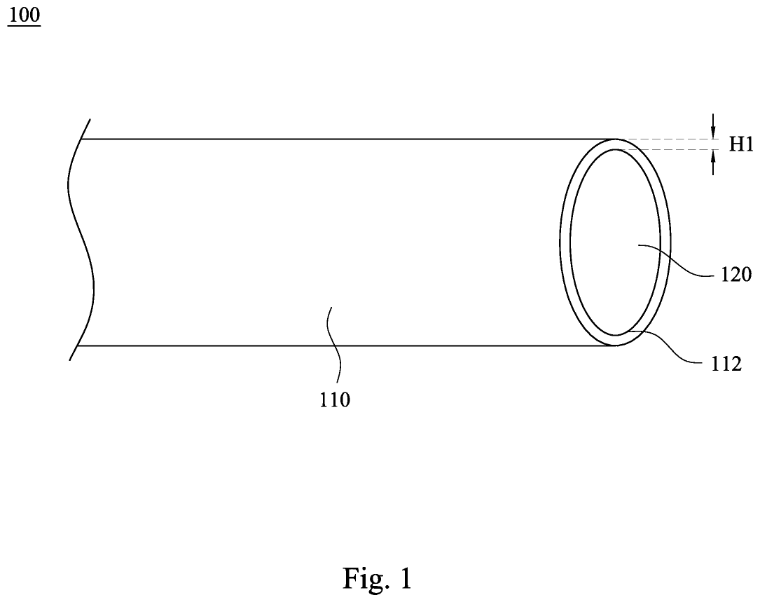

Another aspect of the present disclosure provides a coated article. FIG. 1 is a schematic diagram of a coated article according to some embodiments of the present disclosure. Please refer to FIG. 1, the coated article 100 includes a substrate 110 and a coating layer 120 covering a surface 112 of the substrate 110. In some embodiments, the substrate 110 may include wood, but is not limited thereto. For example, the substrate 110 may be a wooden pencil. It should be understood that the shape of the substrate 110 is not limited to that shown in FIG. 1, and the substrate 110 may be selected according to needs.

The coating layer 120 may include any of the foregoing coating compositions. In some embodiments, the coating layer 120 is a matte coating. In other embodiments, the coating layer 120 is a gloss coating. Specifically, the gloss of the surface of the coating layer 120 can be controlled by adjusting a ratio of the smoothing agent to the filler in the coating composition. In some embodiments, the coating layer 120 can protect the substrate 110 and has a function of anti-slip. Specifically, the degree of surface smoothness of the coating layer 120 can be controlled by adjusting a ratio of the smoothing agent to the secondary adhesive in the coating composition. In some embodiments, a thickness H1 of the coating layer 120 is in a range of from about 250 to about 350 μm, but not limited thereto. Specifically, as the temperature increases, fluidity of the coating increases, such that a thin coating layer 120 can be formed when the coating is applied to the substrate 110. Conversely, as the temperature drops, fluidity of the coating decreases, such that a thick coating layer 120 can be formed when the coating is applied to the substrate 110. Therefore, the fluidity of the coating can be controlled by temperature, and thus the thickness of the formed coating layer 120 can be adjusted. In some embodiments, by adjusting the fluidity of the coating, the coating can be applied only once to obtain the desired thickness of the coating layer 120. In other methods, the coating may be repeatedly applied on the substrate 110 to obtain a multilayered coating layer 120.

In some embodiments, the method of forming the coated article 100 may include following steps. First, after any of the aforementioned coating compositions is uniformly mixed, it is heated to about 110° C. to about 230° C. to form a completely melted coating. After that, the above coating is cooled to about 110° C. to about 200° C. and placed in a coating hopper. Next, the coating is maintained at a fixed temperature, and the substrate 110 is passed under the coating hopper with a fixed speed to uniformly apply the coating to the surface 112 of the substrate 110. Finally, the coating is cooled and cured to form the coating layer 120 attached to the surface 112 of the substrate 110, and thus the coated article 100 is formed.

The following examples are used to describe specific aspects of the present disclosure in detail and enable those having ordinary skill in the art to implement the present disclosure. However, the following examples should not be used to limit the present disclosure.

### Example 1: Preparation of Coating

100 g of ethylene-vinyl acetate copolymer, 10 g of low density polyethylene, 11 g of paraffin wax, 3 g of calcium stearate, 2 g of rosin pentaerythritol ester, and 3.5 g of pigment were placed in a heated and stirring tank. Without heating, the above mixture was stirred for 10 minutes to make it uniformly mixed. After that, the heating and stirring tank was heated to 160° C., and the mixture was heated while stirring to completely melt the mixture to form a coating.

### Example 2: Fabrication of Coated Article

The uniformly melted coating of Example 1 was cooled to 130° C., and after 15 minutes of heat stabilization, the coating was flown into the coating hopper. The periphery of the coating hopper was heated to maintain the coating at 130° C. After that, a log pen pole was transported with a fixed speed to make it pass through the coating hopper to complete one coating process. By this, a coating layer having a thickness of about 300 μm was formed on the surface of the log pen pole. Therefore, a coated article is obtained.

### Example 3: Preparation of Coating

80 g of polyvinyl chloride, 13 g of low density polyethylene, 15 g of paraffin wax, 2 g of calcium stearate, 1 g of rosin pentaerythritol ester, and 4.5 g of pigment were placed in a heated and stirring tank. Without heating, the above mixture was stirred for 10 minutes to make it uniformly mixed. After that, the heating and stirring tank was heated to 160° C., and the mixture was heated while stirring to completely melt the mixture to form a coating.

### Example 4: Fabrication of Coated Article

The uniformly melted coating of Example 3 was cooled to 120° C., and after 15 minutes of heat stabilization, the coating was flown into the coating hopper. The periphery of the coating hopper was heated to maintain the coating at 120° C. After that, a log pen pole was transported with a fixed speed to make it pass through the coating hopper to complete one coating process. By this, a coating layer having a thickness of about 300 μm was formed on the surface of the log pen pole to obtain a coated article.

As described above, according to the embodiments of the present disclosure, a coating composition and a coating article are provided. This coating composition does not contain organic solvents. Compared with coatings that require the use of organic solvents such as the nitrocellulose Lacquers, the coating composition of the present disclosure does not cause the issues of volatilization of organic solvents and thus is more environmentally friendly. In addition, when the coating composition is applied to a substrate, it can be quickly cured to form a coating layer that adheres to the surface of the substrate without sticking, thereby improving the coating efficiency. If repeated coating is required, waiting time for molding can also be greatly reduced. Therefore, no additional drying equipment is required, and thus can save space.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A coating composition, comprising:
a primary adhesive, in an amount of about 65.0 to about 85.0 wt % based on a total weight of the coating composition;
a modifier, in an amount of about 5.0 to about 15.0 wt % based on the total weight of the coating composition;
a smoothing agent, in an amount of about 5.0 to about 15.0 wt % based on the total weight of the coating composition;
a filler, in an amount of about 1.0 to about 3.0 wt % based on the total weight of the coating composition;
a secondary adhesive, in an amount of about 0.5 to about 10.0 wt % based on the total weight of the coating composition; and
a pigment, in an amount of about 1.0 to about 10.0 wt % based on the total weight of the coating composition.

2. The coating composition of claim 1, wherein the primary adhesive comprises polyester, polyurethane (PU), polyvinyl chloride (PVC), ethylene-vinyl acetate (EVA) copolymer or a combination thereof.

3. The coating composition of claim 2, wherein the primary adhesive is ethylene-vinyl acetate copolymer and has a melting point of about 70° C. to about 100° C.

4. The coating composition of claim 3, wherein in the ethylene-vinyl acetate copolymer, vinyl acetate is in an amount of about 5.0 to about 40.0 wt % based on the total weight of the ethylene-vinyl acetate copolymer.

5. The coating composition of claim 3, wherein the ethylene-vinyl acetate copolymer has a melt flow index of about 20 to about 90 g/10 min.

6. The coating composition of claim 2, wherein the primary adhesive is polyurethane and has a melting point of about 110° C. to about 140° C.

7. The coating composition of claim 6, wherein the polyurethane has a melt flow index of about 15 to about 30 g/10 min.

8. The coating composition of claim 1, wherein the modifier comprises low density polyethylene (LDPE), high density polyethylene (HDPE), linear low density polyethylene (LLDPE) or a combination thereof.

9. The coating composition of claim 1, wherein the smoothing agent comprises beeswax, paraffin wax, microcrystalline wax, polyethylene wax (PE wax) or a combination thereof.

10. The coating composition of claim 1, wherein the filler comprises talcum powder, zinc stearate, calcium stearate, calcium carbonate or a combination thereof.

11. The coating composition of claim 1, wherein the secondary adhesive comprises maleic acid resin, alkyl phenolic resin, rosin pentaerythritol ester, hydrogenated hydrocarbon resin or a combination thereof.

12. The coating composition of claim 1, wherein the coating composition has a melting point of about 100° C. to about 180° C.

13. A coated article, comprising:
a substrate having a surface; and
a coating layer covering the surface of the substrate, wherein the coating layer comprises the coating composition of claim 1.

14. The coated article of claim 13, wherein the substrate comprises wood.
